(19) United States
(12) Patent Application Publication
(10) Pub. No.: US 2019/0385192 A1
(43) Pub. Date: Dec. 19, 2019

(54) DIGITAL MEDIA GENERATION

(71) Applicant: A Million Ads Holdings Ltd, London (GB)

(72) Inventor: Steve DUNLOP, London (GB)

(21) Appl. No.: 16/479,106

(22) PCT Filed: Jan. 15, 2018
(86) PCT No.: PCT/GB2018/050099

§ 371 Date: Jul. 18, 2019

(30) Foreign Application Priority Data
Jan. 18, 2017 (GB) 1700877.2

(51) Int. Cl. G06Q 30/02; H04N 21/81; H04N 21/2668

(52) U.S. Cl. CPC G06Q 30/0251; G06Q 30/0277; H04N 21/2668; H04N 21/812

(57) ABSTRACT

A method and system for generating digital content comprising forming a template by defining a set of template elements, assigning the template elements with playback positions, defining a set of alternative data items for each template element, receiving a plurality of digital clips, associating each digital clip in the plurality of clips with a data item of the set of alternative data items, and generating an output for a combination of data items including a data item for each template element, by arranging the received digital clips associated with each data item in the combination of data items according to the playback positions of the template elements in the template.

### FIELD OF THE INVENTION

The present invention relates to a system and method for generating digital data and in particular automatically generating a stream or output of audio and/or video for personalised distribution. These may be advertisements or continuity announcements, for example.

### BACKGROUND OF THE INVENTION

Audio media remains a popular form of communication leading to the rise of many audio streaming services, especially for music. Such services may provide audio to users on computers, radios and mobile devices. Whilst many of the digital works provided as audio streams or downloads may be relevant for a wide audience, certain forms of audio media may benefit from some level of customisation or personalisation.

For example, some music streaming services are funded from advertising revenue but these audio advertisements will be of low impact and effectiveness if such advertisements are of no interest or relevance to them. Music streaming services therefore provide advertisements using servers that monitor when, how and what particular advertisements are served to individual users, perhaps including rules to prevent the repetition of a particular advertisement too many times or within a particular time period.

Even in the absence of advertisements, there can be a need to provide users with automatically generated audio to introduce tracks or provide other information in audio format. However, this can be difficult when each user has the ability to customise the particular type and order of audio content that they receive.

There is also a need to be able to provide digital works that are relevant to a particular set of real-world situations, which may vary from user to user or location to location, for example. It is currently not possible to provide or generate customised digital works on this level of granularity in real-time (e.g. specifically focussed on a particular user that is operating a device with parameters that may vary quickly). Such difficulties may also arise from the processing limitations of devices (especially mobile devices) that may render digital works to users or communications networks to supply such data to these devices.

Such problems are not limited to audio media. Services may provide video services to users and it can be important to provide personalised content during or between such types of digital content (or within or between different types of content).

Therefore, there is required a method and system that can generate such personalised media or digital content.

### SUMMARY OF THE INVENTION

A stream or file that forms a digital work is generated based on a template for the overall digital content. The template contains template elements that can have different values or parameters. Each template element represents a position in the stream or content in which different clips may be inserted or played back. The template may also define common or background elements, such as one or more audio streams or files that will always be included at particular locations or between, before, or after alternative clips. Each template element has a set of alternative data items that can each be matched or associated with a particular clip or segment (e.g. alternatives). Therefore, the output comprises one possible clip for each data item and so a combination of data items together with the template defines how the output is generated. The template also defines particular playback positions (e.g. absolute, relative or sequential locations) in which to insert the clips in the output. The output may also comprise content (e.g. audio and/or video) that is common for any combination of data items for a particular template. Therefore, the playback positions defined by the template may indicate where each clip is inserted in the common or background content.

The output may be generated on demand based on a particular combination of data items or parameters that is received. Alternatively, an output for every combination used to generate data items, may be generated in advance and before they are required. In this case, each output may be stored together with or associated with an indication of the particular combination of data items that was used to generate it. The particular output may be retrieved based on receiving a request indicating the combination of data items specific to that stored output (e.g. within a database or file system). Instead of providing the output, an address of the location of the particular output may be returned so that the output may be retrieved by a playback device, such as a mobile device, for example.

Other parts of the system may determine when to request and/or playback a particular output and may record that such an output has been played back or rendered on particular devices to particular users (i.e. a log may be kept for users or groups of users). This process may be managed for digital content generated for advertisements by an advertisement server that may base such decisions on rules or other requirements. Demand for a particular stream or file may be made from the playback device itself or an external server or entity. This demand may include none, some or all of the data items used to generate or request the output. The data items may come from different sources, for example.

The methods described above may be implemented as a computer program comprising program instructions to operate a computer. The computer program may be stored on a computer-readable medium.

According to a first aspect there is provided a method for generating digital content comprising the steps of:
forming a template by:
   defining a set of template elements;
   assigning the template elements with playback positions;
   defining a set of alternative data items for each template element;
receiving a plurality of digital clips;
associating each digital clip in the plurality of clips with a data item of the set of alternative data items; and
generating an output for a combination of data items including a data item for each template element, by:
   arranging the received digital clips associated with each data item in the combination of data items according to the playback positions of the template elements in the template. Therefore, digital works may be generated automatically for a particular use or situation. The content can be more relevant to the user and based on real world data. This solution also allows the provision of digital content to be customised to a greater degree and served to a user without increasing the computing burden on a device that is used to render or play the content, especially on mobile devices. Clips may be digital works but typically short components or incomplete sections of material that are used to generate longer or complete composite digital works. They may be recorded (e.g. voice recordings) or otherwise generated. Clips may be combined or edited to form different clips, for example.

Preferably, the method may further comprise the step of storing the received digital clips in a data store and wherein the step of generating the output further includes retrieving the received digital clips associated with each data item from the data store. Therefore, the clips (e.g. audio and/or video clips) may be reused and retrieved when required to be incorporated into the output.

Preferably, the method may further comprise the step of storing the output as a file associated with the corresponding combination of data items. Therefore, an output for many or all possible combinations of data items can be generated in advance of being required. Therefore, this may further reduce the burden on computing resources as only the required output file needs to be retrieved rather than generated when needed. The file may have a file container and/or may encode the digital work using a codec.

Preferably, the file may be stored over an external network such as the internet, for example.

Optionally, the method may claim further comprising the step of receiving a request for the output before the step of generating the output. This avoids needing to store the different outputs, which may include a very large number of different combinations but at the expense of generating outputs in real time. A further enhancement is only to generate the outputs when they are needed and/or to store or cache them and supply the previously generated output corresponding to a similar or identical request (i.e. for the same data items) so that they do not need to be generated more than once.

Preferably, the request may include information indicating the combination of data items. This may include the data items themselves, identifiers of each data item or other code or lookup identifier for a particular combination of data items.

Optionally, the request may originate from a playback device. The request may originate from other entities.

Optionally, the request may originate from a content management server or other entity. The request may be passed between any entity in the system.

Optionally, the step of arranging the received digital clips associated with each data item in the combination of data items according to the playback positions of the template elements may further comprise the steps of:

providing a further digital clip having locations corresponding to each template element; and

inserting each digital clip into the further digital clip at the locations corresponding to the template elements. Therefore, different outputs may be generated for each particular combination of data items and corresponding clips. This may be useful for generating different ad campaigns based on the same data and set of clips (e.g. audio and/or video.)

Advantageously, the method may further comprise repeating the generating step for a plurality of combinations of alternative data items in a template and storing each generated output as a file associated with the corresponding combination of data items. Therefore, full or substantially full sets of outputs may be generated in advance as a batch job or equivalent.

Preferably, the method may further comprise the step of receiving a combination of data items or indication of data items after repeating the generating step and in response retrieving the file corresponding with the received combination of data items. Therefore, a file or other digital representation of the output may be retrieved for a particular set of data items out of many possible combinations.

Optionally, the step of retrieving the file may further comprise providing an address of the file or digital representation.

Preferably, the address may be a uniform resource locator, URL. Other address types may be used such as IP addresses or database identifies (e.g. database keys).

Optionally, the address may be sent to a playback device, the method may further comprise the playback device retrieving the file from the address or storage location.

Optionally, each set of alternative data items may include:

days of the week,

user details,

location,

times of the day,

weather categories,

playback device type, and/or

playback service type. Other types may be used.

Optionally, the method may further comprise the step of compiling the data items from different data sources.

Optionally, the data sources may include a playback device, GPS data, a weather server, and a remote server.

Preferably, the output may be an advertisement or a continuity announcement. This may be audio or video material.

Preferably, the method may further comprise the step of playing or rendering the output on a user device.

Optionally, wherein the digital content is audio or video content and the digital clips are audio or video clips.

In accordance with a second aspect there is provided a system, comprising:

at least one processor; and

a memory storing instructions that when executed by at least one processor cause the system to:
form a template by:
   defining a set of template elements;
   assigning the template elements with playback positions;
   defining a set of alternative data items for each template element;
   receiving a plurality of digital clips;
   associating each digital clip in the plurality of clips with a data item of the set of alternative data items; and
   generating an output for a combination of data items including a data item for each template element, by:
   arranging the received digital clips associated with each data item in the combination of data items according to the playback positions of the template elements in the template.

Optionally, the system may further comprise a data store (e.g. database or server) configured to store the generated output as a file together with data indicating the combination of data items used to generate the output.

Optionally, system may further comprise a content management server configured to request an address of a file corresponding to the combination of data items used to generate the output of the file.

Optionally, the content management server may be further configured to provide a playback device with the address of the file. This can be provided as a message or response.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows® or Linux, for example. The method may be implemented in software using a suitable language, such as Java, Java-script, C, C++ or similar, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a template including template elements used to generate digital content such as audio and/or video content;

FIG. 2 shows a schematic diagram of a method for generating digital content;

FIG. 3 shows sets of data items that may be associated with the template elements of FIG. 1;

FIG. 4 shows a table of data items that may be associated with the template elements of FIG. 1;

FIG. 5 shows a schematic diagram of a portion of the method for creating the digital content;

FIG. 6 shows a flowchart of a method for generating the digital content;

FIG. 7A to 7H show screenshots of a software tool used to generate digital content;

FIG. 8 shows a schematic diagram of a further system for implementing the method of FIG. 6;

FIG. 9 shows a schematic diagram of a further system for implementing the method of FIG. 6; and

FIG. 10 shows a schematic diagram of an example architecture of a system for generating digital content.

It should be noted that the figures are illustrated for simplicity and are not necessarily drawn to scale. Like features are provided with the same reference numerals.

### DETAILED DESCRIPTION OF THE PREFERRED EMBODIMENTS

The following description provides an example implementation of a method and system for generating digital content (e.g. audio content) in the form of an advertisement. However, this system and method may be used to generate other types of digital output as well including, for example, continuity announcements between tracks or programs, video material, textual content and any combinations of these formats. Benefits of this system include the ability to generate content (digital works) that is personalised or configured for a particular context or user and such personalisation or configuration to the content is based on a set of data so that different outputs can be generated and focused for a particular use or user situation. Therefore, the user or listener of the digital content can receive a more focused or personalised service.

The system may be based on the generation of or design of a template for the digital content, which in one example may include a script and particular data items or parameters (e.g. day, time, weather, location, user properties, context, etc.) that may influence alternatives within the script.

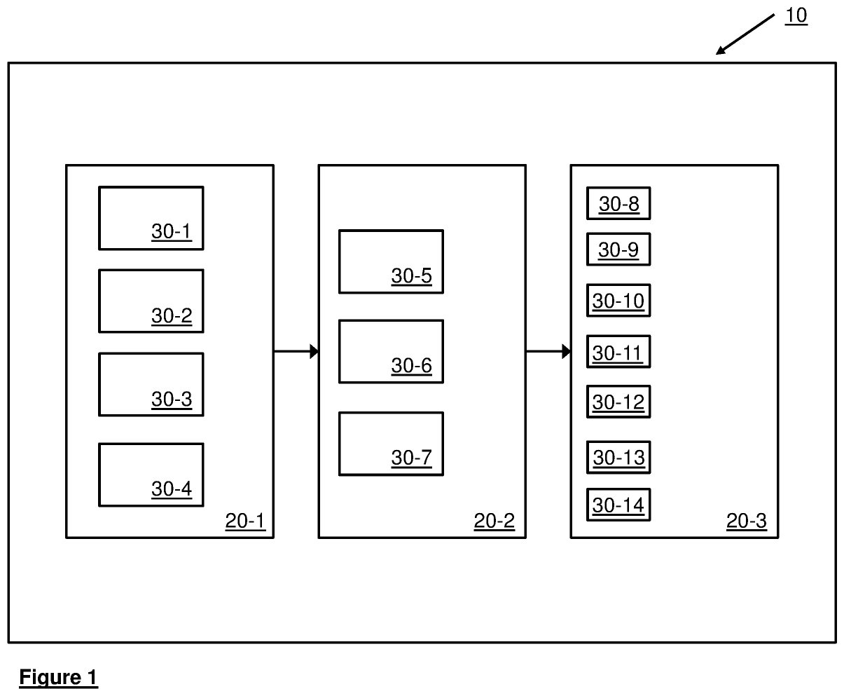

FIG. 1 shows a schematic diagram of a template 10 used to generate digital content. In this example, the digital content is audio content. The template 10 includes a plurality of template elements 20 (20-1, 20-2, 20-3), which correspond with alternative audio clips that may be placed in a particular position within an audio output. The different data items are provided with reference numerals 30-1 to 30-14. In this example, template element 20-1 includes or is associated with a set of four alternative data items 30-1 to 30-4. Template element 20-2 includes three alternative data items 30-5 to 30-7 and template element 20-3 includes seven alternative data items 30-8 to 30-14.

Each data item may itself have an associated audio clip (not shown in this figure). The template 10 may also include an indication of the particular position (or other way to place it) in an audio output where each one of the alternative audio clips may be inserted depending on a particular combination of data items that is received. For example, should a combination of data items include 30-2, 30-7, 30-11, then at the position where template element 20-1 is located in the audio output (e.g. by time code or other data tag) then the audio clip associated with data item 30-3 is inserted at this indicated position (relative or absolute) in the audio output. Audio clip associated with data item 30-7 is inserted at the location or position within the audio output where template element 20-3 is shown. The audio clip associated with data item 30-11 is inserted at the corresponding position in the audio output. These audio clips may comprise the entire audio output or may be placed within a common audio stream or file. In other words, for any combination of data items then there may be at least some audio spaced around or linking the alternative audio clips.

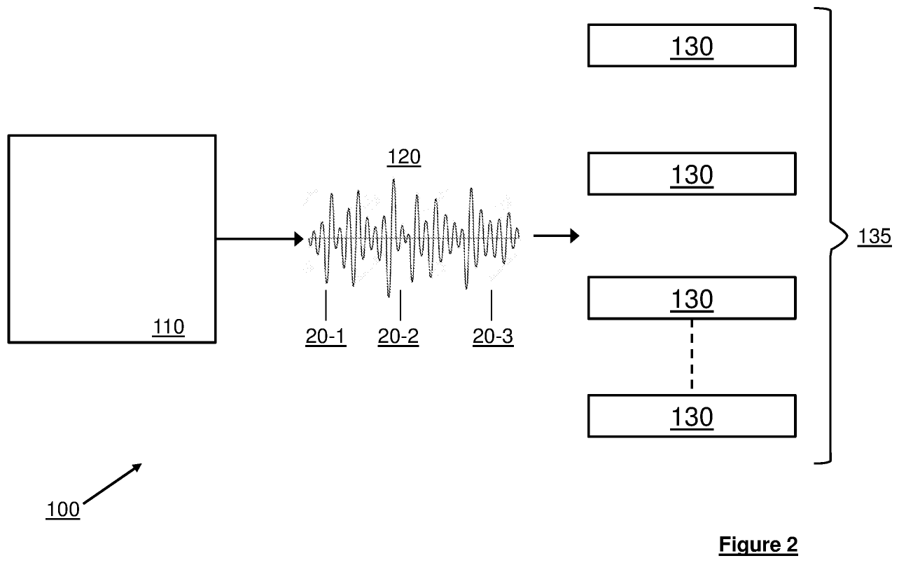

FIG. 2 illustrates schematically a part of the method 100 for generating audio in which a script 110 is used as the basis for creating an item of audio 120 including audio clips associated with each data item 30 (not shown in this figure). Such audio clips may be inserted into a common or initial portion of audio. FIG. 2 indicates the positions where such clips are inserted (or overwrite existing material) by vertical lines labelled with their corresponding template element 20-1 to 20-3. In the particular example shown in FIG. 1, three separate template elements 20-1 to 20-3 are shown. As there are four, three and seven different data items associated with each of the three template elements, then this leads to 4×3×7=84 different combinations and so 84 separate audio outputs 130 that may be generated forming a complete set 135 of outputs (e.g. files).

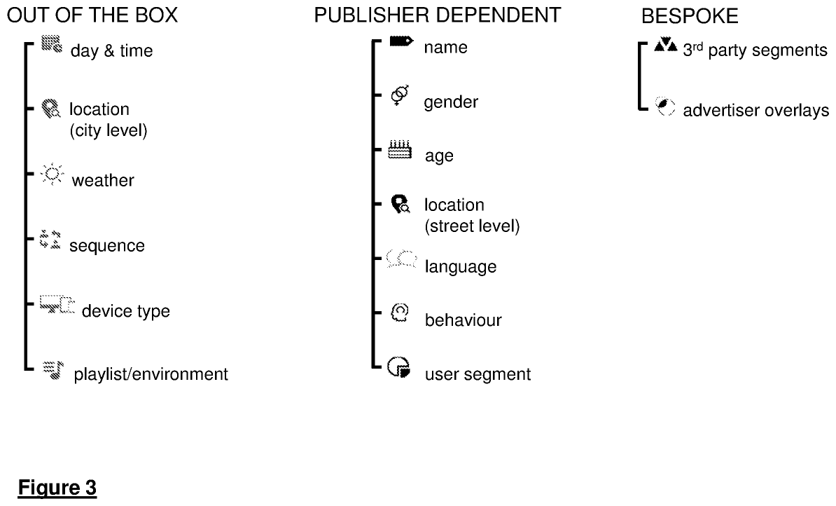

FIG. 3 illustrates example template element data types that correspond with data points and associated clips. A software tool may be used to customise and configure any template for particular sets of digital content outputs. There may be certain set of out-of-the-box data types that may be selected. Other data types may be dependent on different publishers. Bespoke content may also be defined.

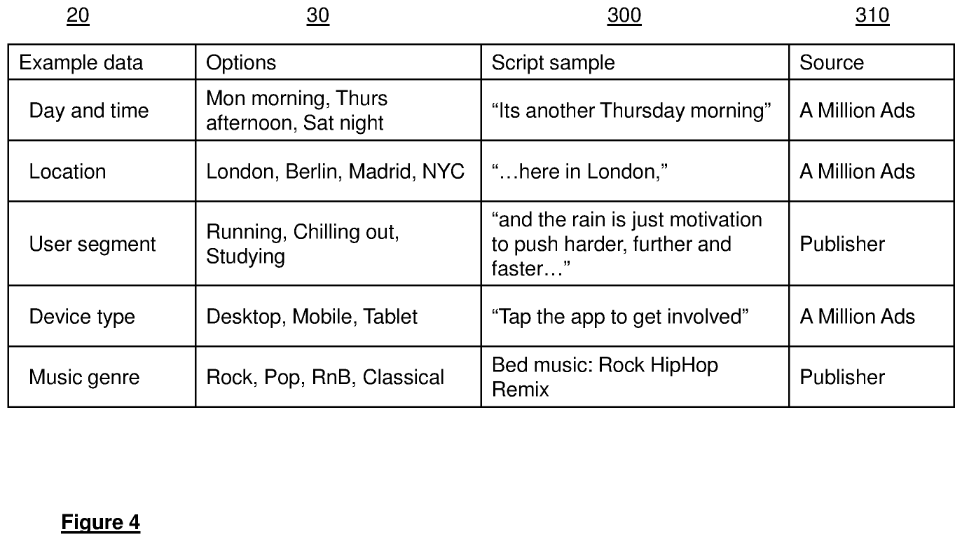

FIG. 4 shows an example table of template element types 20, data items or options 30, script samples 300 used to generate the data items 30 and sources of the data 310. The script samples 300 may be read out and recorded (or otherwise captured) to form data items 30 in the form of audio or content clips.

FIG. 5 shows a schematic diagram of a method 400 for generating the content outputs 120. This figure shows the aspect of the method that places the audio clips associated with each template element 20-1 within an audio file 410 or output according to the template 10 and received data. Each data point (e.g. attribute) may be linked to an audio element e.g. voice over, sound effect or music track. The data point or points for each user (e.g. static or dynamic) determines which audio element or clip is chosen and incorporated into the output file or stream. Where all possible combinations of outputs are created in advance then the data point or points determine which output of set of possible or pre-generated outputs is retrieved. This system delivers the correct combination of audio in real time, making the output (e.g. advert or continuity clip) feel personalised or match the particular combination of input data for individual users at a particular moment.

For example, where two podcasts are selected by a user then an output may be generated or retrieved that links the two (e.g. “that was podcast X and now is podcast Y”). Such linking content may include other personalisations or configurations dependent on the template.

In the example of FIG. 5, there is a single backing track 410 into which each alternative audio clip is inserted or overlaid. In this example, the first template element 20 represents each day of the week. Therefore, there is a set 420 of seven different audio clips that speak each day. There are seven corresponding data items 30 (days of the week) that correspond with each audio clip in the set 420. Between each audio clip may be common audio segments 405. In this example, the data element “Monday” is received or selected (or is being used to generate this particular output). Therefore, the audio clip of a voice reciting “Monday” is inserted at the particular location in the audio output.

The next template element 20 corresponds to location and has a set 430 of 50 different audio clips reciting different towns or cities. Data item “Manchester” is received and so the audio clip for “Manchester” is selected and inserted. The next template element 20 is “segment” and contains four alternative data items in the set 440. In this example, “running” is selected and inserted. The fourth data element 20 is “sequential messages” (i.e. how many times a user has received this particular content or advert). Each time they may receive a different audio clip from the set 450. The last data element corresponds with “device type” and the set of audio clips 460 contains three different clips corresponding to different types of devices (e.g. mobile, desktop, tablet, etc.) Therefore, there may be many thousands of different possible audio outputs 470 for different combinations of data items.

FIG. 6 illustrates a flowchart of the method 600 for operating the system to generate digital content. At step 610 the template 10 may be defined or updated. This may only need to be done once if no changes are required. Templates may be based on previous templates 10 or built new each time.

At step 620 template elements 20 may be defined and associated with playback positions within a common mask or file. Data elements 30 for each template elements 20 are defined at step 630. There may be different numbers of data elements 30 for each template element 20.

Clip (e.g. audio or video clips) may be received at step 640. These may be generated from a script or may be retrieved from existing clips or other sources. Each clip is associated with at least one (or more) data element 30 at step 650. A background or common clip, mask or file may also be received. At step 660 one or more clips may be arranged according to the playback positions defined in the template 10 to form an output (e.g. file or stream). The particular arrangement may be based on a received data set of data elements 30 or carried out for every possible combination and stored for later retrieval.

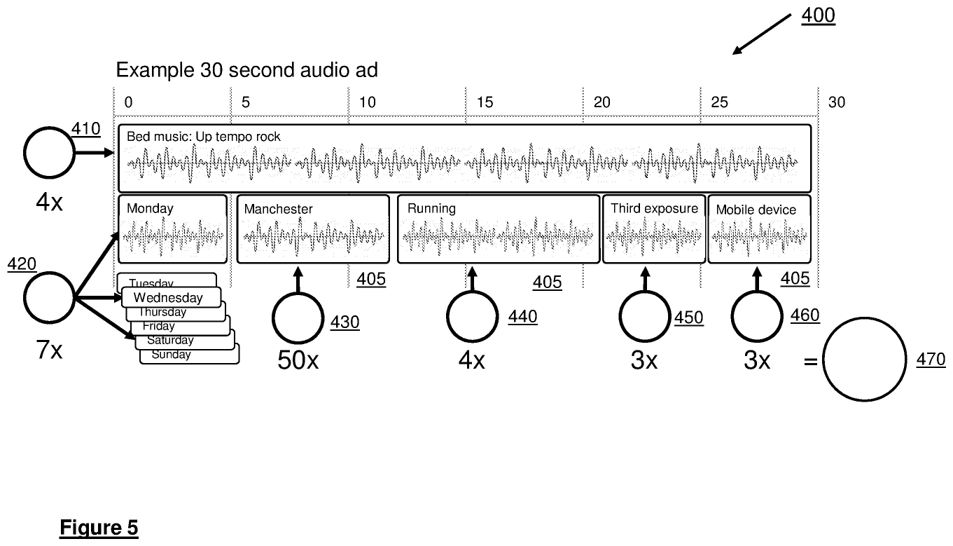

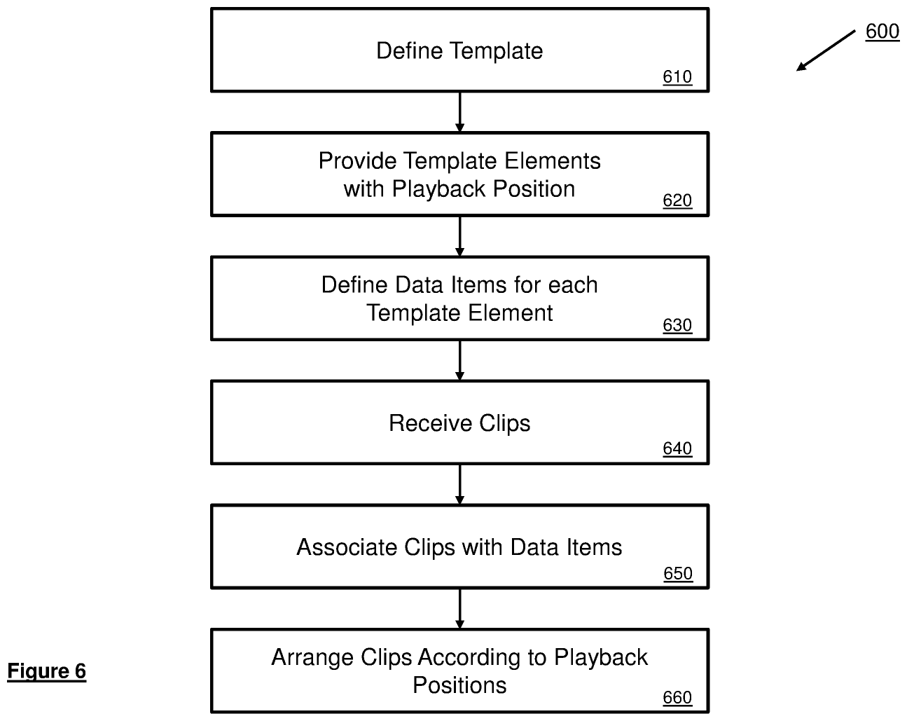

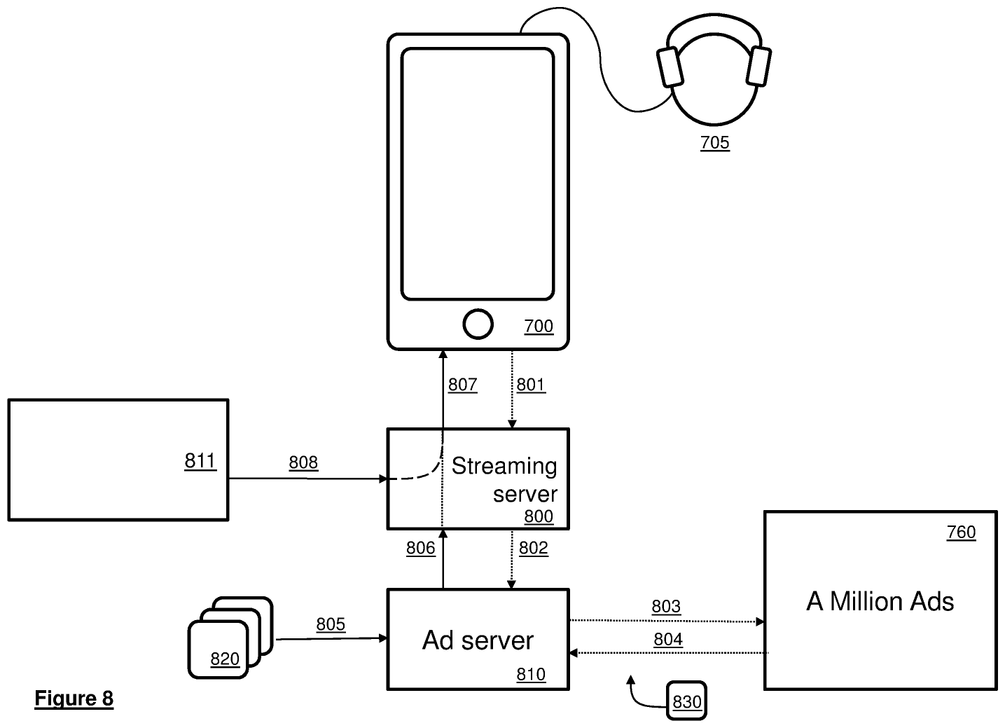

FIGS. 7A to 7H show screen shots of an administration tool user interface for putting the method 600 into effect. This administration tool is provided by software that may be loaded on to a user's computer or provided over a network such as the internet (e.g. through a browser, for example).

A front end interface is designed for creators to write, build and manage data-driven audio adverts or other digital content. Preferably, users log in with a private user name and password or Google account. Ads are stored in scripts which are arranged by campaign and client. A script builder may have at least four components:

Script editor: text-based editor to write scripts and associate text with audio files and data.

Audio sequencer: visual timeline of audio files showing when each element will play. Elements with multiple options can be expanded to show when each option will play. Each option can be shifted in time. The full timeline can be played.

Audition player: audio player that allows the user to enter any combination of data to hear what the audio will sound like for that combination

Publish tool: when edits to the script are complete, the publish tool triggers the batch manager to make all of the possible variations and provides a tag for the ad server.

An admin UI may be an HTML5 app using Angular JS front end framework, for example. App files may be hosted by Amazon AWS S3 or other cloud supplier. All interactions with the system are preferably through REST API calls to Admin API.

FIG. 7A illustrates a login screen (username and password or by Google account, for example) to enable a user to access the system.

FIG. 7B shows a client list view screen indicating a list of clients (e.g. companies who wish to advertise) that the user can create advertisements for. Each client may have multiple campaigns and each campaign may have different scripts or templates 10.

FIGS. 7C and 7D show an example script editor in text editor view mode. Paragraphs may be selected and converted into items such as Bed music, Sound Effect or

Elements, for example. Each item can be attached to or associated with an audio file and a data element.

FIG. 7E shows an example script editor in data view mode. Data and audio options may be linked to lines in the script. Each element may be linked to multiple data types and values. Defaults can be chosen that plays if no rules match.

FIG. 7F shows an example audio sequencer screen. A script may be represented as a timeline with wave form of each audio clip shown in time. Elements with multiple options may be expanded to show the different lengths of each clip. Clips may be dragged left or right in time to sequence them relative to each other.

FIG. 7G shows an example audition player screen. Data may be chosen from the options to inject into the script. The finished mixed audio may be auditioned (e.g. tested).

FIG. 7H shows an example publish screen. Publishing the script locks it for any further edits and triggers the batch manager to make every permutation of the script (e.g. for all data input combinations).

FIG. 8 illustrates schematically the flow of data and messages within at least a portion of the described system. The following numbered paragraphs corresponding with the numbered arrows and actions shown in FIG. 8.

801. The client device 700 (e.g. a smartphone) communicates with a streaming server 800. The user chooses to listen to an audio service that contains audio adverts (such as music streaming services, internet radio or podcast services, for example). Many of these services have associated apps or use a web browser or default audio streaming functionality of the device 700. These services generally provide a catalogue of different audio to choose from and each item may have an associated URL or other address or locator.

The app or client device 700 (such as a mobile handset, desktop PC, appliance audio receiver) connects to the chosen audio stream by using the URL or address of the service that the user 705 has chosen to connect to. When the client device 700 connects with the streaming server 800, a set of data is passed including:

IP address (an address that the device 700 uses to locate itself on the internet or other network);

User agent (a short description of the device and the app being used); and

Identifier (such as a log-on ID, or device ID) that uniquely identifies this device.

802. Streaming server 800 communicates with an ad server 810. The streaming server 800 dictates or determines using an algorithm or rules when in the flow of audio the client device 700 should be served an advert (or other digital content). If an advert is required (e.g. based on rules), then the streaming server 800 may request one (or more) adverts from the ad server 810 and will pass on some or all of the data from the client device 700 and may append additional information such as which audio the user 705 has selected.

803. Ad server 810 chooses which campaign to serve and passes request on to the content generation server 760 (also shown in this figure as “A Million Ads”). The ad server 810 chooses which ad to serve to this client device 700 based on a set of hierarchical decisions, e.g. start and stop date of the campaign, price, number of impressions served, frequency caps, front or back loading of the campaign. Other or different rules may be used in different combinations. Further decisions may be based on the particular user 705. For these, the ad server may collect additional data, such as:

Using the identifier, the ad server 810 can link in to other data sets, such as log-in data (name, age, gender, usage profile, preferences etc); and

Data Management Platforms (DMP) can supply segmentation data so that advertisers can buy audiences on broad criteria, such as whether the user has children, whether they drive a car, what socio-demographic group they are in.

The outcome of these decisions may be to choose which ad campaign to serve. For example, the ad server 810 may call up a non-dynamic, generic ad or may call for a dynamic creative ad from the content generation server 760 at this stage. The request to the content generation server 760 may include: IP, User agent, Device ID, plus or instead of any of the additional data that the ad server 810 accessed above, as required by a script or content definition. These data may be passed in a form of an HTTPS GET request with data appended to the query string.

FIG. 8 assumes there is no demand-side platform (DSP) used in the process and the ad server 810 talks directly to the content generation server 760.

804. The content generation server 760 responds to the ad server 810 with a VAST (video ad serving template) tag 830. The content generation server 760 uses any or all of the data contained in the request to process a creative generation request and respond with a VAST tag (the IAB standard for communicating between digital ad servers).

805. The audio (or other format) files 820 are retrieved by the ad server 810 from

the address or addresses contained with the VAST tag 830.

806. The ad server 810 interprets the contents of the VAST tag 830 and sends an audio file to the streaming server 800. The VAST tag 830 contains the location of the audio file 820 to be inserted into the audio stream. Other meta-data may be included in the VAST tag 830, such as the location of any companion image and link, plus tracking tags to be fired when the ad is played. The data may be passed in different forms or using other data communication processes.

807. Streaming server 800 transcodes the audio and streams it to the client 700 with ads in situ.

808. This entire process happens in milliseconds and is mixed seamlessly into the audio stream so the user will not be aware of the process that has taken place to choose the ads. The content selected by the user 705 is served by a content provider 811 through the streaming server 800. The ads or other generated content are added to this stream.

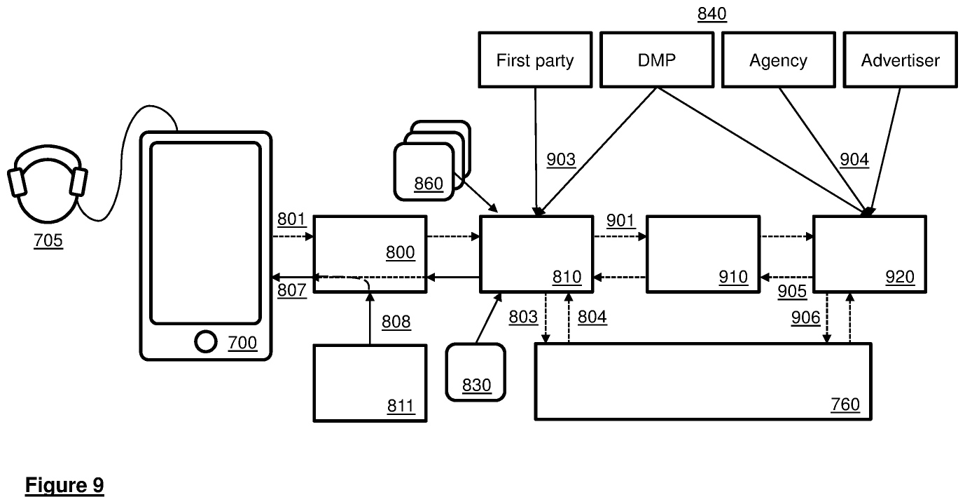

FIG. 9 shows a schematic diagram of an alternative system architecture based on the system shown in FIG. 8. Similar components and data communications steps have been provided with similar reference numerals. However, this alternative system includes some additional components including a DSP 910 and one or more agency trading desks 920. The data flow in this example may be described as:

801. Client device 700 communicates with a streaming server 800. Streaming server 800 communicates with ad server (as described with respect to FIG. 8). The Ad server 810 assembles data from a range of sources. The ad server 810 chooses which ad to serve to this client device 700 based on a set of hierarchical decisions. A further tier of decisions brings third party exchanges (DSP) 910 into the process to determine if they would like to bid to serve an ad to this user 705. If the DSP 910 wins the slot, then the request is passed on to the DSP layer. The process carried out using the system shown in FIG. 9 assumes that the DSP 910 wins such a slot and that the content generation server 760 has a recorded relationship with this DSP 910 and can serve dynamically created content via the DSP 910 (as opposed to direct to the ad server 810).

901. Ad server 810 passes ad request to DSP 910. When the ad server 810 passes the request on to the DSP 910, then this may comprising only forwarding IP, User agent and Device ID data.

903/904. Agency trading desk (as a layer on top of the DSP layer) assembles data from a range of sources. The Agency trading desks (e.g. Accuen, Vivaki, Xaxis, etc.) may use a trading desk platform that is linked to the DSP 910 (such as The Tradedesk or AppNexus) to buy segments of audience across many platforms programmatically (i.e.

without a direct trading relationship with each publisher/media owner). Each agency trading desk may have their own set of audience data that they collect through all of their digital advertising trading activity. This is likely to be similar to DMP data described with reference to the process of FIG. 8.

There are two possible scenarios at this stage:

905/906. The trading desk 920 and the DSP 910 may pass the request with assembled data to be processed. The trading desk 920 then passes the request on to the content generation server 760 (906). The data contained in this request may include: IP,

User agent, Device ID, Agency trading desk data, for example. The content generation server 760 uses any or all of these data to process the creative (generate the content) and respond with a VAST tag 830.

Alternatively, the assembled data may be passed back via the DSP 910 to the Ad server 810 that subsequently passes the request to the content generation server 760. This responds to the ad server 810 with a VAST tag 830.

806. The ad server 810 interprets the contents of the VAST tag 830 and sends an audio file to the streaming server 800 (as described with respect to FIG. 8).

807. Streaming server 800 transcodes the audio and streams it to the client 700 with ads in situ. Non-dymanic generic ads 860 may also be served to the client 700.

808. The content selected by the user 705 is served by the content provider 811 through the streaming server 800. The ads or other generated content are added to this stream.

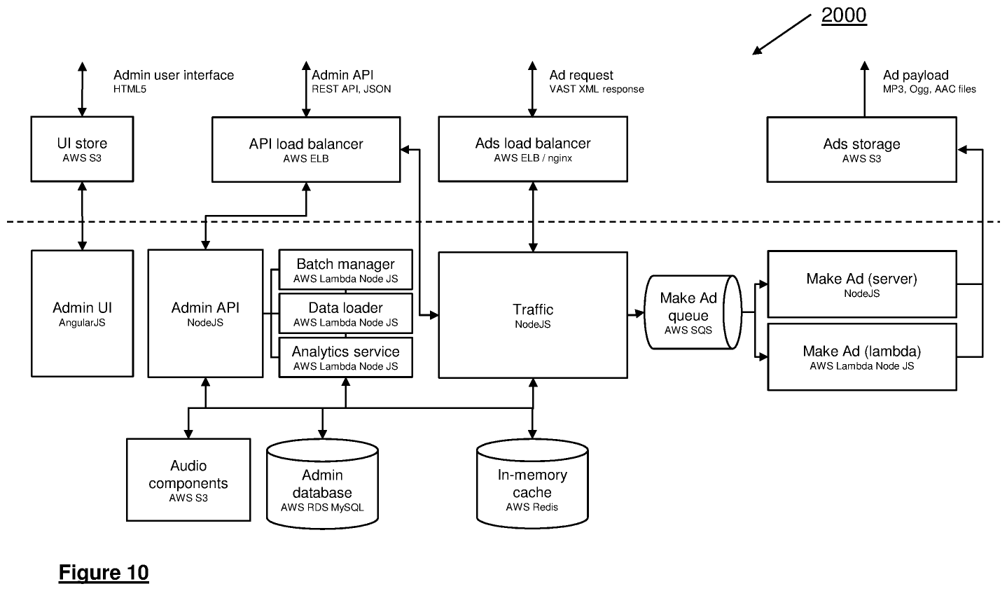

FIG. 10 shows an example technical architecture 2000 of the system. This figure shows logical processing components of the system. An API interface may be used to control all admin functions (Create, Read, Update and Delete of Clients, Campaign, Scripts) including user authentication, uploading audio and sequencing audio. A batch manager may handle the creation of all permutations of a script by cycling through all of the possible inbound data options and requesting them from the Traffic component to add them to the cache and triggering Make Ad component. Data loader handles communication with third party data sources (e.g. any one or more of weather, results and time zone services) and stores the results in Redis or other data structure server. This keeps the concerns separated (Admin API and Traffic performance is not impacted by external API availability). Analytics service regularly requests aggregated data from the server logs to display charts and statistics for each script.

Admin API is a NodeJS component (e.g. hosted in Elastic Beanstalk) that allows the system to scale vertically and horizontally. MySQL database may be used as storage. AWS S3 may be used to store audio assets and clips. Batch manager, Data loader and Analytics service are preferably Node JS Lambda functions.

Traffic is the ad-tech speed node of the system. Traffic receives requests from publisher ad servers and responds with personalised creative (e.g. the audio or video output). Traffic receives ad requests at high volume and is expected to respond in 10s of milliseconds.

The NodeJS component may be hosted in Elastic Beanstalk to vertically and horizontally scale (i.e. improve performance by increasing the size of each server and/or the number of servers). This component preferably uses memory cache for fastest possible storage and retrieval.

The following table describes the Traffic Process Flow:

| | |
|---|---|
| Request received | HTTPS GET request arrives at ads.amillionads.com/go endpoint |
| Data cleanser | Receives inbound data payload, validates and cleans. |
| | Data is sourced from the request headers (e.g. IP address, |
| | User agent), meta parameters (e.g. script id, source, |
| | output type, file type, zone, user id) and data payload |
| | (e.g. any data related to the request passed from the ad |
| | server, such as first name, age etc) |
| Script loader | Loads the script required by the ad request from Admin API and |
| | caches response |
| | Each script specifies which data fields it requires to power |
| | the data-driven creative |
| Parse loaderr | Loads parser required by the ad request from Admin API and |
| | caches response |
| Parse inputs | Parser translates the data from the cleanser into a uniform |
| | taxonomy (different publishers have different standards for |
| | data transfer. Parser converts this so that data from any |
| | publisher in any form can be mapped to scripts) |
| User handler | A hash of the user id and script id is created and checked |
| | against the user cache. If no user id is present in the |
| | request, we create one from a hash of the IP and User agent |
| | The request and script counts for this user id are updated |
| Match data and insert | Data required by the script is matched from the parsed data. If |
| defaults | no data is delivered in the request via the parser then |
| | default data is added: |
| | IP address maps to location |
| | Location maps to timezone |
| | Timezone gives the hour, day, time of day, |
| | daypart |
| | Location gives current weather condition |
| | User agent gives Device type (mobile, tablet, |
| | desktop, car etc.) and Device operating system |
| | (Android, iOS, Windows etc.) |
| | User id gives User impression and click count |
| Run rules engine and | The rules engine combines the script with the data to create a |
| Make EDL | unique Edit Decision List (EDL) |
| | The EDL contain the locations of each of the component audio |
| | elements and instructions on how to assemble them |
| Check cache using hashed | This EDL is hashed and checked against the cache of previously |
| EDL | made EDLs |
| | If cache miss: pass EDL to Make Ad queue to create the audio |
| | file |
| | If cache hit: return the location of the previously made audio |
| Create output | This can be specific to the publisher (some require industry |
| | standards, such as VAST, others require JSON or even the |
| | audio file itself) |
| Return response | Send the response to the requester |

Make Ad (server) is an audio engine that turns EDLs into audio files. It runs independently and simultaneously (they don't need to know anything about the data or the requester) which enables many ads to be created at once. Make Ad polls the queue and take the first EDL off the list. There are two queues in operation: a preview queue and a batch queue which have different latency and scalability characteristics:

Preview queue is always on which provides low latency but is slower to scale

Batch queue is an on demand AWS Lambda function that provides medium latency but can scale to many hundreds of concurrent instantiations

As will be appreciated by the skilled person, details of the above embodiment may be varied without departing from the scope of the present invention, as defined by the appended claims.

For example, whilst audio generation and clips have been described, video, text or other type of content may be generated using similar techniques.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for generating digital content comprising the steps of:
forming a template by:
defining a set of template elements;
assigning the template elements with playback positions;
defining a set of alternative data items for each template element;
receiving a plurality of digital clips;
associating each digital clip in the plurality of clips with a data item of the set of alternative data items; and
generating an output for a combination of data items including a data item for each template element, by:
arranging the received digital clips associated with each data item in the combination of data items according to the playback positions of the template elements in the template.

2. The method of claim 1 further comprising the step of storing the received digital clips in a data store and wherein the step of generating the output further includes retrieving the received digital clips associated with each data item from the data store.

3. The method of claim 1 or claim 2 further comprising the step of storing the output as a file associated with the corresponding combination of data items.

4. The method of claim 3, wherein the file is stored over an external network.

5. The method according to any previous claim further comprising the step of receiving a request for the output before the step of generating the output.

6. The method of claim 5, wherein the request includes information indicating the combination of data items.

7. The method of claim 5 or claim 6, wherein the request originates from a playback device.

8. The method of claim 5 or claim 6, wherein the request originates from a content management server.

9. The method according to any previous claim, wherein the step of arranging the received digital clips associated with each data item in the combination of data items according to the playback positions of the template elements further comprises the steps of:
providing a further digital clip having locations corresponding to each template element; and
inserting each digital clip into the further digital clip at the locations corresponding to the template elements.

10. The method according to any previous claim further comprising repeating the generating step for a plurality of combinations of alternative data items in a template and storing each generated output as a file associated with the corresponding combination of data items.

11. The method of claim 10 further comprising the step of receiving an indication of a combination of data items after repeating the generating step and in response retrieving the file corresponding with the received combination of data items.

12. The method of claim 11, wherein the step of retrieving the file further comprises providing an address of the file.

13. The method of claim 12, wherein the address is a uniform resource locator, URL.

14. The method of claim 12 or claim 13, wherein the address is sent to a playback device, the method further comprising the playback device retrieving the file from the address.

15. The method according to any previous claim, wherein each set of alternative data items includes:
days of the week,
user details,
location,
times of the day,
weather categories,
playback device type, and/or
playback service type.

16. The method according to any previous claim further comprising the step of compiling the compilation of data items from different data sources.

17. The method of claim 16, wherein the data sources include a playback device, GPS data, a weather server, and a remote server.

18. The method according to any previous claim, wherein the output is an advertisement or a continuity announcement.

19. The method according to any previous claim further comprising the step of playing the output on a user device.

20. The method according to any previous claim, wherein the digital content is audio or video content and the digital clips are audio or video clips.

21. A system, comprising:
at least one processor; and
a memory storing instructions that when executed by the at least one processor cause the system to:
form a template by:
defining a set of template elements;
assigning the template elements with playback positions;
defining a set of alternative data items for each template element;
receiving a plurality of digital clips;
associating each digital clip in the plurality of clips with a data item of the set of alternative data items; and
generating an output for a combination of data items including a data item for each template element, by:
arranging the received digital clips associated with each data item in the combination of data items according to the playback positions of the template elements in the template.

22. The system of claim 21 further comprising a data store configured to store the generated output as a file together with data indicating the combination of data items used to generate the output.

23. The system of claim 21 or claim 22 further comprising a content management server configured to request an address of a file corresponding to the combination of data items used to generate the output of the file.

24. The system of claim 23, wherein the content management server is further configured to provide a playback device with the address of the file.

25. A computer program comprising program instructions that, when executed on a computer cause the computer to perform the method of any of claims 1 to 20.

26. A computer-readable medium carrying a computer program according to claim 25.

27. A computer programmed to perform the method of any of claims 1 to 20.
